(19) United States
(12) Patent Application Publication
(10) Pub. No.: US 2017/0295801 A1
(43) Pub. Date: Oct. 19, 2017

(54) Oil Based Organic and All Natural Pest Repellent for Humans and Pets

(71) Applicant: Joann Waite, Deer Park, WA (US)

(72) Inventor: Joann Waite, Deer Park, WA (US)

(21) Appl. No.: 15/132,132

(22) Filed: Apr. 18, 2016

(51) Int. Cl. A01N 65/26; A01N 65/36; A01N 65/28; A01N 65/22; A01N 65/06; A01N 65/44; A01N 25/00

(52) U.S. Cl. CPC A01N 65/26; A01N 65/44; A01N 65/36; A01N 25/00; A01N 65/22; A01N 65/06; A01N 65/28

(57) ABSTRACT

The present invention disclosed herein is directed to a natural pest repellent composition and the method for producing such a composition. The composition comprises a mixture herb oils, citrus oils, and wood oils safe for human and pet topical use to repel pests. The composition includes organic and natural materials and is capable of repelling pests such as insects, fleas, flies, mosquitoes, bed bugs, and ticks. The oil extracts from the herbs, citrus, and wood release a repelling agent to discourage the pests. The present invention provides a natural eco-friendly repellent that is pleasant smelling to humans. The present invention is distinctly different from prior art because it does not contain any synthetics, water, or alcohol in the composition.

### CROSS-REFERENCE TO RELATED APPLICATIONS

None

### STATEMENT REGARDING FEDERALLY SPONSORED RESEARCH OR DEVELOPMENT

None

### REFERENCE TO SEQUENCE LISTING, A TABLE, OR A COMPUTER PROGRAM LISTING COMPACT DISC APPENDIX

None

### BACKGROUND OF THE INVENTION

The present invention pertains to the field of pest repellents. Prior art that the present invention is drawn to is the organic and natural solutions to pest repellents. What is missing in the art are pure natural and organic compounds that repel pests and do not evaporate because of the use of water or alcohol to dilute the effectiveness of the natural pest repelling essential oils. This present invention is made from 100% essential oils without the use of water or alcohol as a carrier.

Prior art includes the use of man-made or synthetic compounds to prolong the longevity of effective essential oils, synthetic compounds have been found to adversely affect the eco-system and human health. The present invention uses only essential oils. This application is a non-provisional application.

### BRIEF SUMMARY OF THE INVENTION

The object of the present invention is to provide a safe eco-friendly pest repellent wherein the composition is 100% natural essential oils which are readily available through USDA Certified Organic wholesalers.

The present invention is safe in reference to the topical use by humans of all ages and household pets such as dogs and cats. As noted in several articles in the US National Library of Medicine/National Institutes of Health (NLM/NIH) using synthetic chemicals cause major risk to human health and the ecosystem. The present inventions repels such pests as mosquitoes, flies, fleas, ticks, and gnats using essential oils from plants considered to be environment friendly. Repelling such pests is important to the public for the prevention and spread of diseases transmitted by such pests and to limit the annoyance of such pests for humans and household pets. The use of 100% natural essential oils is important as essential oils are renewable resources. The present invention uses essential oils widely known for centuries for their effectiveness to repel pests and presently studied and confirmed by published articles such as those found in the NLM/NIH. Further the present invention extends the live of essential oils effectiveness and protection time by using Vanillin and Basil both found to be effective in the present invention compounds and noted in articles found in NLM/NIH.

### TECHNICAL FIELD OF THE INVENTION

This application relates in general to the field of methods and compositions related to pest repellents and control.

### BRIEF DESCRIPTION OF THE SEVERAL VIEWS OF THE DRAWING

None

### DETAILED DESCRIPTION OF THE INVENTION

The scope of the present invention is not limited to the background described in connection with pest control or pest deterrents compositions and related methods.

The present invention relates to a natural pest repellent composition and method. More specifically, the present invention pertains to a safe, eco-friendly, natural, green, and method of making safe, green, natural eco-friendly pest repellents which repels insects and ticks harmful to household pets and humans.

Bug Repellents and Pesticides are chemical substances that deter, incapacitate, ill, or otherwise discourage any pests from coming in contact with the covered object. Of bug repellents and pesticides the target pests can include insects, parasites, plant pathogens, weeds, mollusks, birds, fish, nematodes, and microbes that destroy property, because nuisance, spread disease, or are disease paths. Although pesticides have many benefits pesticide use raises a number of environmental and health concerns for both humans and animals. Pesticides may reach water, air, and soil and cause pollution and contamination causing further and more harm than good for the public. Pertinent to this invention is the relationship between pesticides commonly known as bug repellents on humans and animals. Common to science is the understanding many pesticides are toxic to humans and animals and may cause acute and delayed health effects to those who are exposed. Exposure to pesticides is known to cause a variety of adverse health effects, ranging from skin and eyes irritations to more severe effects such negatively impacting the nervous system, and causing cancer.

The present invention includes only natural and organic oils in an embodiment not limited to spray, roll-on, or spritz application topically to human skin and animal fur intended to repel insects.

The present invention provides a pest repellent composed of natural and organic essential oil ingredients. The composition consists of essentially fractionated Coconut oil, Neem oil, Eucalyptus oil, Clove oil, Lavender oil, Vanilla oil, Basil oil, Lime oil, Peppermint oil, Apricot kernel oil, and Cedar wood oil. The composition can be sprayed, rolled, or rubbed on skin of humans or fur of animals. The advantages of the present invention is the use of natural and organic ingredients and the method of creating the composition eliminates the need for extreme temperatures and conditions thus being more eco-friendly ingredients as well as process.

The following description will further explain the object and benefits for the public of this natural and eco-friendly pest-repellent.

For the purposes of presenting a brief and clear description of the present invention the preferred embodiment will be discussed as used for deterring, discouraging, and repelling any pests such as insects and ticks.

To facilitate the understanding of the present invention, terms are defined herein which meanings have as commonly understood by a person of ordinary skill relevant to the present invention. Terms such as “a”, “an” and “the” are not proposed to denote a singular use or ingredient, but include the general scope of a specific example. The terminology herein is used to describe specific embodiments of the present invention, but their usage does not restrict the invention, except as defined in the claims.

As used herein, the phrase “pest repellent” encompasses but not limited to pest repellents, repel pests, repel insects, and insect repellent. The term “preferred concentration” regarding a composition to repel pest refers to that dosage of ingredients sufficient exert the desired activity.

The term pests that the present invention repels includes but is not limited to lice, mosquitoes, fleas, flies, ticks, and gnats.

The term “household pets” refers to those considered small animals as outlined by the practice of veterinary medicine in that small animals include dogs and cats, those common in U.S. households.

The present invention is important to the public to repel lice, mosquitoes, fleas, flies, ticks, and gnats to prevent the spread of skin irritation and rashes, and to prevent the occurrence of louse-borne diseases such as epidemic typhus, trench fever, and epidemic relapsing fever in the United States. Mosquitoes are controlled to prevent the spread of mosquitoes bearing such diseases as malaria; St. Louis, Eastern, Western, West Nile and LaCrosse encephalitis; yellow fever and dengue fever. Tick species transmit diseases such as Lyme disease, tick-borne relapsing fever, ehrlichiosis, and Rocky Mountain spotted fever. Flies because they are known to carry are known for spreading at least 200 known pathogens and parasites to humans. Gnats are an annoyance and contribute to the spread of infectious diseases.

Essential oils included in the present invention include but are not limited to the list of essential oils and additional essential oils as identified in 21 CFR 172.510 and 172.515 as having been used previously in foods, although they are not on the GRAS (generally recognized as safe) list.

The Code of Federal Regulations, Title 21, recognizes primary essential oils in this invention as GRAS compositions that do not require regulatory agency approval. See particularly parts 182.10, 182.20, 182.40, 182.50, and 182.60 of 21 CFR.

The present invention includes the list of essential oils as part of the base composition and the following paragraph list for scent variations. Apricot (Prunus Armeniaca) Kernel Oil, Basil (Ocimum Basilicum) Oil, Cedarwood (Cedrus atlantica) Oil, Citronella (Cymbopogon nardus) Oil, Clove (Eugenia Caryophyliata) bud oil, Coconut (Caprylic/Capric Triglyceride) fractionated oil, Eucalyptus (Eucalyptus Globulus) Oil, Lavender (Lavandula angustifolia) Oil, Lime (Citrus aurantifolia) Oil, Peppermint (Mentha piperita) Oil, Neem (Azadirachita indica) Oil.

The present invention uses a variation of the following but are not limited to the following essential oils for scent, Balm Mint (Melissa officinalis) Oil, Bee Balm (Monarda didyma) Oil, Bergamot (Citrus aurantium bergamia) Oil, Birch (Betula aba) Oil, Bitter Orange (Citrus aurantium amara) Oil, California Nutmeg (Torreya californica) Oil, Camellia Sinensis Oil, Cardamon (Elettaria cardamomum) Oil, Chamomile (Anthemis nobilis) Oil, Cinnamon (Cinnamomum cassia) Oil, Clove (Eugenia caryophyllus) Oil, Cloveleaf (Eugenia caryophyllus) Oil, Coriander (Coriandrum sativum) Oil, Coriander Seed Oil, Cyperus Esculentus Oil, Cypress (Cupressus sempervirens) Oil, Eucalyptus Citriodora Oil, Fennel (Foeniculum vulgare) Oil, Geranium Maculatum Oil, Ginger (Zingiber officinale) Oil, Grapefruit (Citrus grandis) Oil, Jasmine (Jasminum officinale) Oil, Laurel (Laurus nobilis) Oil, Lavandin (Lavandula hybrida) Oil, Lemon (Citrus Medica Limonum) Oil, Lemongrass (Cymbopogon schoenanthus) Oil, Mandarin Orange (Citrus nobilis) Oil, Matricaria (Chamomilla Recutita) Oil, Chamomile (Anthemis nobilis) Roman Oil, Musk Rose (Rosa moschata) Oil, Myrrh (Commiphora myrrha) Oil, Nutmeg (Myristica fragrans) Oil, Orange (Citrus aurantium dulcis) Flower Oil, Orange Oil, Parsley (Carom petroselinum) Seed Oil, Passionflower (Passiflora incarnate) Oil, Patchouli (Pogcstemon cablin) Oil, Pine (Pinus palustris) Oil, Pine (Pinus pinea) Kernel Oil, Pine (Pinus pumiho) Oil, Rosemary (Rosmarinus officinalis) Oil, Rose Oil, Rosewood (Aniba rosseodora) Oil, Sage (Salvia officinalis) Oil, Sandalwood (Santalum album) Oil, Sassafras Officinale Oil, Spearmint (Mentha viridis) Oil, Sweet Marjoram (Origanum majorana) Oil, Thyme (Thymus vulgaris) Oil, Vetiveria Zizanoides Oil, Wild Mint (Mentha arvensis) Oil, and Ylang Yang (Cananga odorata) Oil, in any combination that maintains the claims of the present invention.

Additionally various embodiments of the present invention are discussed in detail below, it should be respected that the present invention provides related inventive conceptions that can be embodied in a diversity of detailed contexts. The specific embodiments discussed herein are merely demonstrative of specific ingredients, ways to make, and use the invention and do not restrict the scope of the invention.

The present invention uses the listed method of preparing the natural pest repellent composition, comprising the steps of:

holding the ingredients in a room at about ambient temperature in individual solvent glass containers and then combining the essential oils to create the pest repellent composition by;

Adding coconut oil, apricot kernel oil, and neem oils together in one solvent glass container at ambient temperature creating the base; adding rosemary oil to said base; adding clove oil to said base; adding basil oil to said base, adding lime oil to said base; adding vanilla oil to said base; adding peppermint oil to said base; adding lavender oil to said base; adding cedar wood oil to said base; adding citronella oil to said base.

The method of preparing a natural pest repellent without limitations further comprising the steps of:

Preserving the composition in glass or any safe for solvent bottles.

Securing a fitting lid to glass bottle or container appropriate for the bottle and or container size.

Preserving said composition in lidded glass or solvent safe bottles at ambient temperature. The method of preparing without limitations a natural pest repellent composition.

The final volume percent of said Fractionated coconut oil is about 29.5% to 31%; a final volume percent of said refined apricot kernel oil is about 5%; a final volume percent of said rosemary oil about 5%; a final volume percent of said clove oil from about 5%; a final volume percent of said neem oil from about 10%; a final volume percent of said basil oil is about 3%; a final volume percent of said lime oil is about 3%; a final volume percent of said peppermint oil is about 5%; a final volume percent of said vanilla oil is about 3%; a final volume percent of said lavender oil is about 8%; a final volume percent of said cedar wood oil is about 18%; and a final volume percent of said citronella oil is about 5%.

The scent of the present invention is without limitation is pleasant to humans and safe for humans and household pets to use topically.

Without limitations the present invention uses sustainable methods of production.

The present invention meets the consumers' demand of protection from insects that are safe, pleasant to use and environmentally sustainable.

The present invention does not use any synthetics, alcohol, or water in the compound.

### DESCRIPTION OF THE PRIOR ART

Devices and repellents have been disclosed in the prior art that relate to insect repellant compositions. These include devices that have been patented and published in patent application publications. Some of these patents describe a composition of Eucalyptus oil and at least one diluent selected from the group consisting of various essential oils, lecithin, benzyl alcohol, Citronellal, and d-limonene. Another patent describes an insect repellent solution comprising a combination of at least two essential oils; citrus peel tincture, and vinegar, another with garlic. These formulations and methods of producing the same, however, are costly, difficult to synthesize, less eco-friendly, and developed to kill pests. The following is a list of formulations deemed most relevant to the present disclosure, which are herein described for the purposes of highlighting and differentiating the exceptional aspects of the present invention, and further highlighting the disadvantages existing in the prior art.

For example, U.S. Published Patent Application Number 2013/0142893 to Bessette discloses pesticidal compositions containing Eucalyptus oil and/or wintergreen oil and methods for using the same. The pesticidal compositions comprise Eucalyptus oil and at least one diluent selected from a group of wintergreen oil, Peppermint oil, mineral oil, phenyl ethyl propionate, lecithin, benzyl alcohol, Citronellal, d-limonene, safflower oil, soybean oil, and sesame oil. The pesticidal composition of Bessette is primarily used against fungus, bacterial, insects, arachnids, larvae, and larvae eggs. Though Bessette discloses use of plant essential oils to be used against invertebrate pests, Bessette does not disclose the use of Clove, Eucalyptus, fractionated Coconut oil and the other oils used in this present invention. The present invention comprises of Neem, Clove, Eucalyptus, Citronella, and Lavender that produce a repelling agent to discourage insects. Additionally, the pesticidal compositions of Bessette utilize synthetic versions of plant essential oils that may contain toxins such as pesticides, fertilizers, or carrier oils. In contrast, the present invention utilizes organically grown plants, thereby providing a better alternative to an existing pest repellent to the user.

U.S. Published Patent Application Number 2010/0196520 to Elraz (“Elraz '520”) discloses an insect repellent solution comprising a combination of at least two essential oils with an emulsifier and citrus peel tincture, and vinegar. The formulation is prepared by mixing the essential oils with an emulsifier and citrus tincture, and adding the mixture to distilled water at a temperature of 40° C. so that the final volume of water is 90% and the final volume of vinegar and oil mixture are each 5%. The formulation is thereafter mixed for approximately 2 hours using a mechanical stirrer. While the formulation of Elraz '520 combines active ingredients possessing repelling effects on insects, the active ingredients are normally immiscible and require an emulsifier to stabilize the formulation. In contrast, the present invention does not require an emulsifier to encourage the suspension of one ingredient in another. Additionally, the present invention does not require an extensive stirring and does not contain any water.

Similarly, U.S. Published Patent Application Number 2011/0229589 to Elraz (“Elraz '589”) also provides an insect repellent solution comprising vinegar and a combination of at least two essential oils. More specifically, Elraz '589 discloses formulation comprising tee tree oil, vinegar, and essential oil selected from a group of Citronella, Eucalyptus oil, and lemon grass oil. The formulation further comprises an emulsifier in an amount of up to about 10% volumes per volume. The emulsifier is mixed with a combination of essential oils before being added to water and vinegar. The mixture is stirred for about 2 hours at ambient temperatures using a mechanical stirrer. Thereafter, the mixture is rested for approximately 24 to 72 hours prior to use. While the formulation of Elraz '589 combines active ingredients possessing repelling effects on insects the ingredients differ from the present invention, which includes fractionated Coconut oil, Neem, Clove, Basil, Vanilla, Lime, Peppermint oils, and Cedar wood oil. Additionally the present invention does not use water as a solvent. Additionally, the present invention does not require an emulsifier or extensive stirring to combine the ingredients and uses a cold press process for extracting the ingredient oils and steam distilled process for the Citronella and other ingredients.

Another device, U.S. Published Patent Application Number 2013/0156839 to Messina discloses geraniol oil-based formulations, which may be applied to various surfaces to deter wildlife pests. The geraniol oil-based formulations further comprise mint oil, caster oil, sodium lauryl sulfate, kaolin, and xanthan gum. Although geraniol oil is known for use in plant based mosquito repellents, it is commonly used in perfumes and in flavors such as peach, raspberry, and grapefruit, among other flavors. As such, bees and other insects can associate the geranoil oil scent with nectar-bearing flowers, which can attract bees and other insects rather than repelling them. In contrast, the composition of the present invention is not made attractive to pests. The pest repellent composition of the present invention comprises herb oils, citrus oils, and wood oils that produce powerful odors that repels pests.

Additionally U.S. Pat. No. 4,376,784 to Harney discloses pesticidal esters of pyrethrin or pyrethroid type in which the methylene group bonded to the ester carbonyl and/or ester oxygen bears a fluorine substituent. While the pesticidal esters of pyrethrin or pyrethroid type disclosed in Harney are very toxic to wide varieties of insect and other invertebrate pests, the esters are costly and difficult to synthesize. Moreover, the difficulty in deriving ester derivatives which contain a fluoro substituted methylene group α- to the ester carbonyl and/or α- to the ester oxygen results in an unpredictable yield of the desired product. In contrast, the present invention provides a method of producing a natural pest repellent composition that is easy to control. Thus, the method of the present invention yields desired product with no contamination and no unpredictable yield.

Another U.S. Published Patent Application Number US20150086656 A 1 to Bailey-Jackson discloses a natural pesticide composition and the method for producing such a composition. The composition comprises a mixture of distilled water, isopropyl alcohol, Eucalyptus oil, Eucalyptus extract, wintergreen oil, and garlic. The composition includes organic and natural materials and is capable of repelling and destroying pests such as insects and parasites. The extract and oil from the herbs and the garlic can externally release a repelling agent to discourage the pests and the alcohol dehydrates the insects. Though both Bailey-Jackson and the present invention provides a natural eco-friendly pesticide that is safe for use on plants, as well as animals and people alike, the present invention is only intended for use on animals and people. The present invention does not use garlic, water, or isopropyl alcohol thus the present invention is unlikely to evaporate or loose potency due to water and isopropyl alcohol ingredients. The present invention compounds have an appealing scent to humans as opposed to the compound by Bailey-Jackson.

Another U.S. Published Patent number US20120171313A1 to Stephanie L. Boone which the invention disclosed is directed to a natural pesticide composition, insecticides, insect growth regulators, and compositions for interfering with a neuromodulator, neurotransmitter, or neurohormone action of an insect's nervous system.

The present invention provides a natural eco-friendly pesticide that is safe for use on household pets and people alike. Unlike Boone, the present invention uses 100% pure unrefined, virgin, cold pressed oils, and fractionated coconut oil. Boone discloses the use of fragrant synthetic chemicals, and derivatives and discloses the use of synthetically created ingredients such as synthetic fragrance chemicals, silicone, and synthetic or man-made, chemicals such as Siloxane. The present invention is natural in that it uses essential organic oils, natural fractionated Coconut oil which is 100% pure and natural, extraction method of cold pressed and refined creating the medium-chain triglycerides (MCT's) which produces the liquid, fractionated, form of Coconut oil and done in steam distillation.

Additionally Boone discloses the use of water as an embodiment to dilute the composition specifically the Neem oil. Neem oil breaks down in water. The present invention does not use water the present invention uses as a carrier fractionated Coconut oil significantly different texture, product consistency, scent, and use on human skin and animal fur. Benefits of the present invention using Coconut oil as the carrier oil includes but is not limited to the improvement in animal coats and is widely recognized for the benefits to human skin.

### SUMMARY OF DIFFERENCE BETWEEN PRIOR ART AND PRESENT INVENTION

These prior art devices have several known drawbacks, which distinguish them from the present invention. The present invention discloses without limitations oil based essential oil pest repellent composition, which contain a mixture of herb oil, plant extracts, fruit oils, and wood oilS. The formulation of the present invention makes such composition effective for repelling a wide variety of pests. Moreover, the preparation of such composition does not require extensive synthesis of each of the ingredients, prolonged period of stirring, or exposure to extreme temperatures. Accordingly, the method of production of the pest repellent composition of the present invention is consistent from batch to batch, thus resulting in invariable performance for repelling pests that is safe for humans and household pets.

The present invention substantially differs in composition and process elements from the prior art, which overcomes the disadvantages of the prior art devices, and consequently it is clear that there is an urgent need in the art for an improvement to the existing pest repellant compositions and processes. In this regard the present instant invention substantially fulfills these needs. The process for producing the present invention is the adding of the essential oils and stirring them together in a food grade container or mixer or commercial food grade mixer.

It is the present invention, which will provide a new and improved natural and eco-friendly solution to household pet and human pest repellents and none of the disadvantages. The present invention is substantially composed of natural and organic essential oils.

The present invention provides a new combination of natural ingredients pleasant smelling to humans and household pets.

Another objective of the present invention is to include only natural and organic ingredient essential oils known widely as pest repellents and safe when applied to household pet fur (coats).

Furthermore the present invention provides a new and improved natural pest repellent that is free of common skin and respiratory irritants contained in dyes and synthetic fragrances and compounds harmful to human health.

Also another objective of the present invention is providing improved natural, eco-friendly biodegradable oils, made from renewable resources.

Another benefit of the present invention that the composition of natural and organic essential oils does not contain water or man-made chemicals or synthetics known to be harmful to human health.

Another objective of the present invention is to provide a new and improved natural and eco-friendly pest repellent wherein the method of producing the same composition is simple to control and replicate.

The pest repellent composition of the present invention is an oil based solution comprising substantially of 30% fractionated Coconut oil, 18% Cedar wood oil, and 10% Neem oil. The oils are from organic and natural processes described below.

The extraction and purification processes without limitations include cold press process to extract the oils or a steam distilled process. Through the cold press process the oils are extracted (without heating) which produces oils that contain the least amount of impurities.

An explanation of each natural and organic ingredient is given herein. Each ingredient is considered 100% pure through the certified organic processes including but not limited to the cold press and steam distilled process to produce the individual ingredients that together make the all natural and organic pest repellent.

The composition in the present invention does not require further agitation before application. The composition does not separate out. The composition is prepared in a single step procedure, wherein the essential oils act as the carrier. Labeling with state to “shake before use” to ensure the oils are mixed as intended in the claims, however, this has not been found necessary in testing.

There are two active ingredients in the present invention the Neem oil and Citronella.

For this invention the active ingredient within the composition, Neem oil, is used substantially and widely as an anti-bacterial foot cream, and used in topical applications for numerous skin issues. In this present invention Neem is widely used as a natural pest control. Neem is also known for being highly antibacterial, antifungal and anti-inflammatory. Some use Neem to combat acne in the present invention Neem is used as the active ingredient in this pest repellent. Neem oil of the present invention adds to the repellent and deterrent action. Neem is falls into the GRAS classification and is nontoxic to mammals, to the environment. Neem oil and derivatives contributes to controlling pests including insects, mites, ticks, and nematodes also by affecting the pest's behavior and physiology.

Table 1 contains the preferred concentration rnage of the composition of the present invention.

Preferred Concentration Range

| Ingredient | Range Minimum | Range Maximum |
|---|---|---|
| Neem Oil | 9.86% | 11.32% |
| Apricot Kernel Oil | 4.24% | 5.11% |
| Coconut Oil | 29.24% | 31.10% |
| Eucalyptus Oil | 4.81% | 5.51% |
| Peppermint Oil | 4.01% | 4.50% |
| Clove Oil | 4.90% | 5.55% |
| Cedar Wood Oil | 17.9% | 20.10% |
| Vanilla | 2.51% | 3.60% |
| Lime Oil | 2.90% | 3.75% |
| Basil Oil | 2.90% | 3.80% |
| Lavender Oil | 7.75% | 8.90% |
| Citronella Oil | 4.90% | 5.10% |

According to the NCBi at NIH, “Neem is widely known as a natural alternative to DEET, and it has been tested for repellency against range of arthropods of medical importance, with variable results. Several field studies from India have shown very high efficacy of Neem-based preparations contrasting with findings of intermediate repellency by other researchers. However, these contrasting results may be due to differing methodologies, and the solvents used to carry the repellents. Neem has a low dermal toxicity, but can cause skin irritation, such as dermatitis when used undiluted (Malar, J. 2011). The present invention substantially dilutes the Neem to a safe level with other known pest repellents and concentrations of oils. Without limitation the present invention Neem is added in the Coconut oil and with the other compositions to eliminate or substantially limit the skin irritation.

Additionally without limitation Lavender is used in the present invention. Lavendar, Lavandula angustifolia (Lavender) essential oil is widely known for being an insecticidal. Additionally Lavender is also known as an antiseptic but for the present invention Lavender is substantially used for the insecticidal and without limits is also used for scent of the present invention. Organic Lavender is steam distilled, non-irradiated, and GMO free thus producing an oil that is pure and aligned with the present invention's objectives and claims.

As the primary ingredient in the present invention at about 30% cold pressed and refined fractionated Coconut oil is known for a stable shelf life. Without limitation Caprylic/capric Triglyceride (fractionated) Coconut oil is used in the present invention as the carrier oil to for the essential oils. Since MCT (fractionated Coconut oil) is an extraction from Coconuts, the USDA will not allow it to be certified organic yet this is the purest form available to use but when and if the USDA will allow certified organic fractionated Coconut oil without limits this present invention will utilize certified organic ingredients including fractionated Coconut oil.

The present invention uses without limits organic Apricot kernel oil. The Apricot kernel oil is cold pressed and has a nutty scent. Without limits blending the scents of Lavender, Cedar wood, Coconut oil, the citrus this present invention is pleasant smelling to most humans and animals. The Apricot kernel oil is without limits used in the present invention for the finer texture absorbed by the skin and scent.

For the present invention Clove, Eugenia caryophyliata (Clove bud), essential oil holds strong germicidal properties and in the present invention is used without limits as an fast acting contact insecticide compound that is effective on a variety of pests such as but not limited to cockroaches, ants, dust mites, flies. Wasps, spiders, crickets, and fleas. Eugenol is considered minimum risk of damage to the environment. According to the NIH “The most effective of these include thyme oil, geranial, Peppermint oil, Cedar oil, patchouli and Clove that have been found to repel malaria, filarial, ad yellow fever vectors for a period of 60-180 minutes. Most of these essential oils are highly volatile and this contributes to their poor longevity as mosquito repellent. However, this problem can be addressed by using fixatives or careful formulation to improve their longevity” as used in the present invention without limits varieties of Basil and Vanilla. Supported with evidence by the NIH report with Basil and Vanilla 3 species of mosquitoes under cage conditions were repelled for 6-8 hours depending on the mosquito species (Malar, 2011).

For the present invention certified organic Ocimum Basilicum (Basil) essential oil is used without limits for increasing longevity of the volatile ingredients such as Clove, Peppermint, and Eucalyptus. The Basil is steam distilled, and 100% pure and undiluted.

For the present invention without limitations Vanilla is used for increasing longevity of the volatile ingredients such as Clove, Peppermint, and Eucalyptus.

For the present invention Cedar wood, Cedrus deodara, essential oil is steam distilled and wild harvested and is 100% pure and undiluted. Cedar wood is commonly known as an insect repellent. For the present invention Cedar wood essential oil is used substantially as a pest repellent. Cedar wood oil has been described as a powerful abortifacient with little toxicity levels.

For the present invention Cymbopogon nardus (Citronella) essential oil is used without limitation as a widely known to repel fleas, flies, and mosquitoes on both animals and humans. For the present invention the use of Citronella is not limited to the pest repellent it includes but is not limited to the citrus scent. For this invention Citronella is certified organic and steam distilled, 100% pure and undiluted. The Citronella volatility is addressed with the addition of Vanilla and Basil in the present invention.

According to the NIH Eucalyptus (Corymbia citiodora) extract is effect ingredient also known as Vanilla grass Eucalyptus. “Eucalyptus is a potent natural repellent extracted from the leaves of Vanilla grass Eucalyptus trees . . . . Many plant extracts and oils repel mosquitoes, with their effect lasting from several minutes to several hours.” (Malar, J. 2011). For the present invention Eucalyptus is used without limitation and for the purpose of the present invention is 100/o pure and all natural and steam distilled.

Without limitation Peppermint essential oil and any other mint is included as part of the present invention for use of scent and pest repellent. The Peppermint (Mentha piperita) essential oil used in the present invention is certified organic, non-irradiated, GMO free, and steam distilled. For the present invention the Peppermint and any other mint oil is used without limitation for scent and pest repellent.

Lime essential oil, Citrus aurantifolia (Lime) essential oil is used in the present invention without limitation. Lime is commonly known as an effective insecticide for small insect pests and mites. For the present invention Lime is also used for the scent and effectiveness as an insecticide. The Lime in the present invention is certified organic, non-irradiated, GMO free, and cold pressed.

Without limitation the citrus, wood, and herb ingredients are mixed together and aged for approximately 24 hours at ambient temperatures.

Without limitations the composition is poured into a spray, roll on, or pump bottle, or other bottle appropriate for consumers and retail in solvent safe containers.

The present invention is then sealed to prevent air leakage and for purposes of this present invention the composition poured into any container are considered a part of this invention.

The present invention is safe when applied topically to animals and humans. Without limits the composition can be applied topically onto animals and humans.

The composition can also be sprayed directly onto pests such as insects and parasites without harming people or and animals and the surrounding environment.

Without limitation the pest repellent composition of the present invention has been shown to preserve without refrigeration in excess of ten months without loss of effectiveness of the fluid.

It is therefore submitted that the present invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

As used herein, words of approximation such as “without limitation”, “about”, “substantial” or “substantially” refers to a condition that hence so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the state value by at least +/−1, 2, 3, 4, 5, 6, 7, 8, 9, 10, 11, 12, 13, 14, or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing form the concept, spirit, and scope of the invention as defined by the claims.

### PATENT CITATIONS

US201500866656 A1, Sharon Bailey-Jackson, Natural pesticide composition and method of producing, Publication date, Mar. 26, 2015; Filing date, May 9, 2014; Also published as U.S. Pat. No. 9,198,435. U.S. Pat. No. 9,198,435 B2, Sharon Bailey-Jackson, Natural pesticide composition and method of producing, Publication date, Dec. 1, 2015; Filing date, May 9, 2014.

US20120171313A1, Stephanie Lynn Boone, Compositions and methods for applying and manufacturing biopesticides, Publication date, Jul. 5, 2012.

Patent Application Number 2010/0196520, Hanan Elraz, Insect Repellent Formulations, Publication date, Aug. 5, 2010; Filing date, Jun. 15, 2008.

Patent Application Number 2011/0229589, Hanan Elraz, Insect and Plant Disease Compositions and Methods of Use Thereof, Publication date, Sep. 22, 2011.

U.S. Published Patent Application Number 2013/0156839, James J. Messina, Broad spectrum pest repellent compositions and pest management systems. Publication date, Jun. 20, 2013; Filing date Apr. 11, 2011.

U.S. Pat. No. 4,376,784, Donald W. G. Harney, Pesticidal Fluorinated esters of the pyrethin or pyrethoid type. Publication date, Mar. 15, 1983. Filing date, Mar. 21, 1981.

### NON-PATENT CITATIONS

Williamson & Russ, (2015) Cooperative Extension, HGIC, Insects, Diseases & Other Problems, HGIC Less toxic Insecticides. Clemson University. Programs Services Resources County Offices.

Malar, J., Maia, M. F., Moore, S. J., (2011); Published 2011, March 15. Plant-based insect repellents: a review of their efficacy, development and testing. Found on www.ncbi.nlm.nih.gov/pmc/articles/PMC3059459; researchers Moore and Malia salaries funded by the Bill & Melinda Gates Foundation. Article published as part of the Malaria Journal Volume 10 Supplement 1, 2011: Natural products for the control of malaria.

Rehman, Ali, and Khan, (2014). Plant based products: use and development as repellents against mosquitoes: A review. US National Library of Medicine, National Institutes of Health. Elsevier B.V. PMID. 24631763.

1. A natural pest repellent for use on humans and household pets to repel insects and ticks. The natural pest repellent without limitation consists essentially of: Coconut oil in an amount from about 30% by volume; apricot kernel oil from about 5% by volume; neem oil in an amount from about 10% by volume; rosemary oil from about 5% by volume; clove oil from about 5% by volume; lavender oil from about 8% by volume; basil oil from about 3% by volume; lime oil from about 3% by volume; peppermint oil from about 5% by volume; vanilla oil from about 3% by volume; citronella oil from about 5% by volume; and cedar wood oil from about 18% by volume.

2. The present invention without limitation uses Vanilla oil and Basil to expand the longevity of the effect of neem oil.

3. A method of preparing a natural pest repellent composition, comprising the steps of holding the ingredients at about ambient temperature in individual solvent glass containers and then combining the essential oils to create the pest repellent composition is eco-friendly and a sustainable method of production.

4. The method of storing a natural pest repellent composition of claim 1, wherein is said at ambient temperature requires no refrigeration.

5. The scent of the present invention is without limitation pleasant to humans.

6. The use of the present invention is safe for humans and household pets to use topically.

7. The composition of claim 1 in the present invention does not use any synthetics.

8. The composition of claim 1 in the present invention does not use any alcohol.

9. The composition of claim 1 in the present invention does not use any water.

10. The composition of claim 1 in the present invention uses essential oils readily available in the United States through USDA Certified Organic and Natural wholesale distributors.

11. The composition and method to process the present invention meets consumers' demand of protection from insects that are safe, pleasant to use, and environmentally sustainable in support of claims 1, 2, 3, 4, 6, 7, and 10.
